(19) United States
(12) Patent Application Publication
(10) Pub. No.: US 2007/0163126 A1
(43) Pub. Date: Jul. 19, 2007

(54) POWER SCISSORS WITH EXTRA LARGE MOUTH

(76) Inventor: Hsin-Te Huang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/306,831

(22) Filed: Jan. 12, 2006

(51) Int. Cl. B26B 17/00

(52) U.S. Cl. 30/175

(57) ABSTRACT

A pair of power scissors includes a first scissor and a second scissor pivotally connected to the first scissor. The first scissor includes a blade, a shank and a slot. The second scissor includes a blade, a shank and an aperture. A handle is pivotally connected to each of the scissors. Each of the handles includes a pivotal section and a grip. The pivotal section of each of the handles is pivotally connected to the shank of related one of the scissors. The handles are pivotally connected to each other. A fastener is driven in the slot of the first scissor and the aperture of the second scissor so that the blades can be opened to a large extent while the handles do not have to be opened to an extent too large to operate.

### BACKGROUND OF INVENTION

1. Field of Invention

The present invention relates to a pair of power scissors with an extra large mouth.

2. Related Prior Art

Referring to FIG. 11, there is shown a conventional pair of power scissors. Each of the scissors includes a shank 1 at an end and a blade 3 at another end. The scissors are pivotally connected to each other by means of a fastener 2 such as a threaded bolt and a nut. The shank 1 of each of the scissors is connected to a handle 4. The handles 4 can be opened so as to open the blades 3 for receiving an object. The handles 4 can be closed so as to close the blades 3 for cutting the object. The handles 4 can be kept closed by means of a latch 5. However, to cut a thick object, the blades 3 must be opened to a large extent, and the handles 4 must be opened to an extent too large to operate.

The present invention is intended to obviate or at least alleviate the problems encountered in prior art.

### SUMMARY OF INVENTION

According to the present invention, a pair of power scissors includes a first scissor and a second scissor pivotally connected to the first scissor. The first scissor includes a blade, a shank and a slot. The second scissor includes a blade, a shank and an aperture. A handle is pivotally connected to each of the scissors. Each of the handles includes a pivotal section and a grip. The pivotal section of each of the handles is pivotally connected to the shank of related one of the scissors. The handles are pivotally connected to each other. A fastener is driven in the slot of the first scissor and the aperture of the second scissor so that the blades can be opened to a large extent while the handles do not have to be opened to an extent too large to operate.

The primary advantage of the pair of power scissors of the present is that the blades can be opened to a large extent while the handles do not have to be opened to an extent too large to operate.

Other advantages and features of the present invention will become apparent from the following description referring to the drawings.

### BRIEF DESCRIPTION OF DRAWINGS

The present invention will be described through detailed illustration of two embodiments referring to the drawings.

FIG. 1 is a perspective view of a pair of power scissors with an extra large mouth according to the first embodiment of the present invention.

FIG. 2 is an exploded view of the pair of power scissors of FIG. 1.

FIG. 3 is a front view of the pair of power scissors shown in FIG. 1.

FIG. 4 is a front view of the pair of power scissors in another position than shown in FIG. 3.

FIG. 5 is a front view of the pair of power scissors in another position than shown in FIG. 4.

FIG. 6 is a front view of the pair of power scissors in another position than shown in FIG. 5.

FIG. 7 is an exploded view of a pair of power scissors with an extra large mouth according to the second embodiment of the present invention.

FIG. 8 is a front view of the pair of power scissors of FIG. 7.

FIG. 9 is a front view of the pair of power scissors shown in FIG. 8.

FIG. 10 is a front view of the pair of power scissors in another position than shown in FIG. 9.

FIG. 11 is a perspective view of a conventional pair of power scissors.

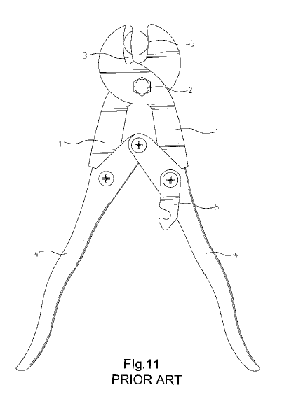

### DETAILED DESCRIPTION OF EMBODIMENTS

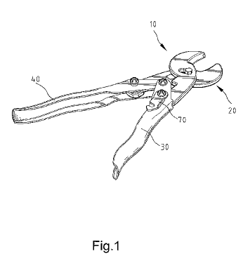

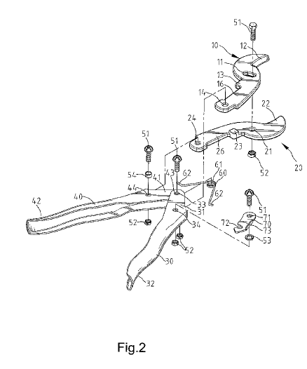

Referring to FIGS. 1 and 2, there is shown a pair of power scissors 10 and 20 with an extra large mouth according to a first embodiment of the present invention. The power scissor 10 includes a blade 12 at an end, a shank 16 at another end, an extension 13 between the blade 12 and the shank 16, a slot 11 between the blade 12 and the extension 13 and an aperture 14 within the shank 16.

The power scissor 20 includes a blade 22 at an end, a shank 26 at another end, a block 23 between the blade 22 and the shank 26, an aperture 21 between the blade 22 and the block 23 and an aperture 24 within the shank 26.

A fastener is driven in the slot 11 and the aperture 21 so as to pivotally connect the power scissors 10 and 20 to each other. The fastener includes a threaded bolt 51 and a nut 52.

The shank 16 is pivotally connected to a handle 30. The handle 30 includes a pivotal section 31 at an end, a grip 32 at another end, an aperture 33 within the pivotal section 31 and an aperture 34 between the pivotal section 31 and the grip 32.

There is used a latch 70 includes an aperture 71 within a section, a cutout 72 within an opposite section and a tab 73 thereon. The tab 73 is used to facilitate the pivotal of the latch 70.

A fastener is driven in the apertures 71, 34 and 14 so as to pivotally connect the latch 70, the shank 16 and the pivotal section 31 to one another. This fastener includes a threaded bolt 51 and a nut 52.

The shank 26 is pivotally connected to a handle 40. The handle 40 includes a pivotal section 41 at an end, a grip 42 at another end, an aperture 43 within the pivotal section 41 and an aperture 44 between the pivotal section 41 and the grip 42.

There is used a sleeve 54. A fastener is driven in the sleeve 54 and the apertures 24 and 44 so as to connect the sleeve 54, the shank 26 and the pivotal section 41 to one another. This fastener includes a threaded bolt 51 and a nut 52.

There is used a torque spring 60 including a helical section 61 and two rectilinear sections 62.

A fastener is driven in the apertures 33 and 43 and the helical section 61 so as to connect the torque spring 60 to the handles 30 and 40. The rectilinear sections 62 are positioned against the handles 30 and 40 so that the torque spring 60 tends to open the handles 30 and 40.

The handles 30 and 40 are both made from a metal strip by means of pressing so as to include a form that looks like a “U” in a cross-sectional view. That is, the handles 30 and 40 both include two parallel portions. The handle 30 actually includes two apertures 33 within of the parallel portions thereof and two apertures 34 within the parallel portions thereof. The handle 40 actually includes two apertures 43 within the parallel portions thereof and two apertures 44 within the parallel portions thereof.

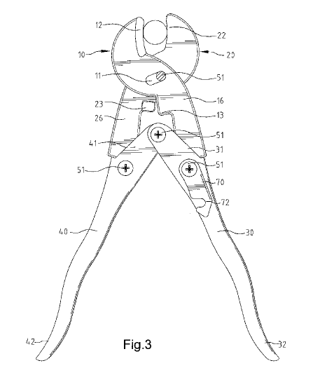

Referring to FIG. 3, the handles 30 and 40 are opened so as to open the blades 12 and 22 so that the blades 12 and 22 can receive an object. The slot 11 allows the blades 12 and 22 to be opened to a large extent while the handles 30 and 40 do not have to be opened to an extent too large to operate.

The handles 30 and 40 are closed so as to close the blades 12 and 22 so that the blades 12 and 22 cut the object. In a first phase of the cutting operation, the blades 12 and 22 are closed about the related fastener.

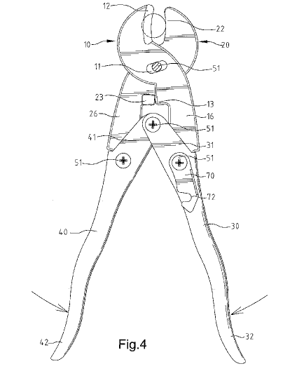

Referring to FIG. 4, in a second phase of the cutting operation, the extension 13 contacts the block 23 so that the handles 30 and 40 are closed about the contact point between the extension 13 and the block 23.

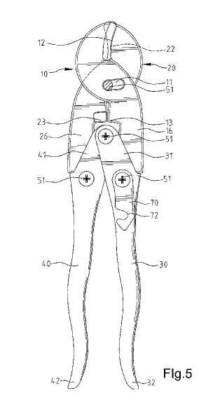

Referring to FIG. 5, the blades 12 and 22 are completely closed so as to cut the object completely.

To cut another object, the cutting operation described referring to FIGS. 3 through 5 can be repeated.

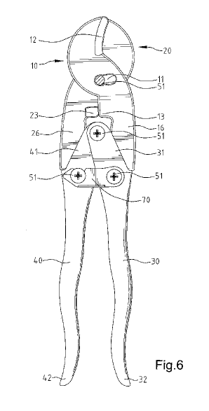

Referring to FIG. 6, to store the pair of power scissors 10 and 20, the latch 70 is pivoted to the sleeve 54 so that the cutout 72 receives the sleeve 54 so as to keep the handles 30 and 40 closed.

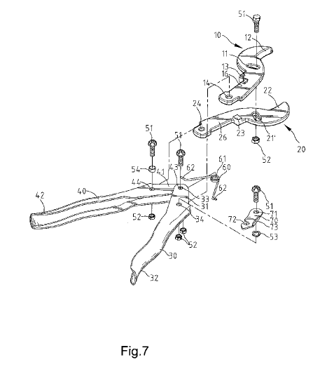

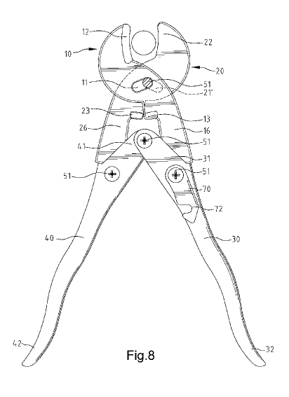

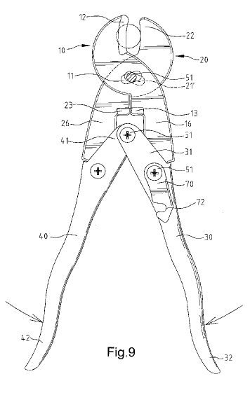

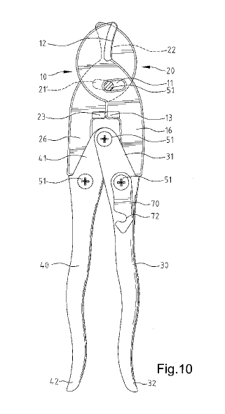

Referring to FIGS. 7 through 10, there is shown a pair of power scissors according to a second embodiment of the present invention. The second embodiment is identical to the first embodiment except that the power scissor 20 includes a slot 21′ instead of the aperture 21. The slot 21′ is identical to the slot 11 regarding shape and function. The second embodiment includes a mouth that can be opened larger than that of the first embodiment.

As shown, the fasteners include the threaded bolts 51 and the nuts 52 in the embodiments. However, the fasteners may be rivets.

In an alternative embodiment, the extension 13 of the first scissor 10 and the block 23 of the second scissor 20 may be omitted. In the first phase of the cutting operation, an end of the slot 11 abuts the fastener that pivotally connects the scissors 10 and 20 to each other. In the second phase of the cutting operation, an opposite end of the slot 11 abuts the fastener that pivotally connects the scissors 10 and 20 to each other.

The pair of power scissors of the present exhibits a significant advantage that the blades can be opened to a large extent while the handles do not have to be opened to an extent too large to operate.

The present invention has been described through the illustration of the embodiments. Those skilled in the art can derive variations from the embodiments without departing from the scope of the present invention. Therefore, the embodiments shall not limit the scope of the present invention defined in the claims.

What is claimed is:

1. A pair of power scissors comprising:
a first scissor comprising a blade at an end, a shank at another end and a slot therein;
a second scissor pivotally connected to the first scissor, the second scissor comprising a blade at an end, a shank at another end and an aperture therein;
a first handle comprising a pivotal section pivotally connected to the shank of the first scissor and a grip opposite to the pivotal section;
a second handle comprising a pivotal section pivotally connected to the shank of the second scissor and a grip opposite to the pivotal section thereof, wherein the first and second handles are pivotally connected to each other; and
a fastener driven in the slot of the first scissor and the aperture of the second scissor so that the blades of the first and second scissors can be opened to a large extent while the handles do not have to be opened to an extent too large to operate.

2. The pair of power scissors according to claim 1 wherein the first scissor comprises an extension thereon, wherein the second scissor comprises a block for contact with the extension of the first scissor so that the scissors can be closed about the contact point between the extension of the first scissor and the block of the second scissor.

3. The pair of power scissors according to claim 1 comprising a latch for keeping the first and second handles closed.

4. The pair of power scissors according to claim 3 wherein the latch is pivotally connected to the first handle.

5. The pair of power scissors according to claim 4 wherein the latch defines an aperture through which a fastener is driven into the first handle.

6. The pair of power scissors according to claim 5 comprising a fastener for pivotally connecting the second handle to the shank of the second scissor, wherein the latch defines a cutout for receiving the fastener that pivotally connects the second handle to the shank of the second scissor so as to keep the first and second handles closed.

7. The pair of power scissors according to claim 6 comprising a sleeve installed on the fastener that connects the second handle to the shank of the second scissor, wherein the cutout of the latch can receive the sleeve so as to keep the first and second handles closed.

8. The pair of power scissors according to claim 1 comprising a spring that tends to open the first and second handles.

9. The pair of power scissors according to claim 8 wherein the spring is a torque spring.

10. The pair of power scissors according to claim 9 wherein the spring is a torque spring.

11. A pair of power scissors comprising:
a first scissor comprising a blade at an end, a shank at another end and a slot therein;
a second scissor pivotally connected to the first scissor, the second scissor comprising a blade at an end, a shank at another end and a slot therein;
a first handle comprising a pivotal section pivotally connected to the shank of the first scissor and a grip opposite to the pivotal section;
a second handle comprising a pivotal section pivotally connected to the shank of the second scissor and a grip opposite to the pivotal section thereof, wherein the first and second handles are pivotally connected to each other; and
a fastener driven in the slots of the first and second scissors so that the blades of the first and second scissors can be opened to a large extent while the handles do not have to be opened to an extent too large to operate.

12. The pair of power scissors according to claim 11 wherein the first scissor comprises an extension thereon, wherein the second scissor comprises a block for contact with the extension of the first scissor so that the scissors can be closed about the contact point between the extension of the first scissor and the block of the second scissor.

13. The pair of power scissors according to claim 11 comprising a latch for keeping the first and second handles closed.

14. The pair of power scissors according to claim 13 wherein the latch is pivotally connected to the first handle.

15. The pair of power scissors according to claim 14 wherein the latch defines an aperture through which a fastener is driven into the first handle.

16. The pair of power scissors according to claim 15 comprising a fastener for pivotally connecting the second handle to the shank of the second scissor, wherein the latch defines a cutout for receiving the fastener that pivotally connects the second handle to the shank of the second scissor so as to keep the first and second handles closed.

17. The pair of power scissors according to claim 16 comprising a sleeve installed on the fastener that connects the second handle to the shank of the second scissor, wherein the cutout of the latch can receive the sleeve so as to keep the first and second handles closed.

18. The pair of power scissors according to claim 11 comprising a spring that tends to open the first and second handles.

19. The pair of power scissors according to claim 18 wherein the spring is a torque spring.

20. The pair of power scissors according to claim 19 wherein the spring is a torque spring.
